(19) United States
(12) Patent Application Publication
(10) Pub. No.: US 2025/0334303 A1
(43) Pub. Date: Oct. 30, 2025

(54) HEAT PUMP SYSTEMS WITH A BYPASS REFRIGERANT LINE

(71) Applicant: Rivian IP Holdings, LLC, Irvine, CA (US)

(72) Inventors: Lingyan JIANG, Irvine, CA (US); Yanping XIA, Irvine, CA (US); Jing HE, Novi, MI (US); Wen LIU, Northville, MI (US); Dewashish PRASHAD, Irvine, CA (US); Ming MA, Irvine, CA (US); Sushant MORE, Irvine, CA (US); Srivatsan MADHAVAN, Irvine, CA (US); Marco ELKENKAMP, Marina Del Rey, CA (US)

(21) Appl. No.: 19/098,863

(22) Filed: Apr. 2, 2025

Related U.S. Application Data
(60) Provisional application No. 63/639,490, filed on Apr. 26, 2024.

(51) Int. Cl. F25B 41/26; F25B 30/02

(52) U.S. Cl. CPC F25B 41/26; F25B 30/02

(57) ABSTRACT

Aspects of the disclosure relate to a heat pump system having a selectable bypass flow path that allows a refrigerant to bypass one or more heat exchangers of the heat pump system. The bypass flow path may be used, for example, to provide enhanced thermal energy (e.g., heat) generation by a compressor for a passenger compartment of a vehicle, particularly in relatively low ambient temperatures and/or during fast charging of a vehicle battery.

### CROSS REFERENCE TO RELATED APPLICATION(S)

The present application claims the benefit of U.S. Provisional Application No. 63/639,490, entitled “HEAT PUMP SYSTEMS WITH A BYPASS REFRIGERANT LINE”, filed Apr. 26, 2024, the entirety of which is incorporated herein for reference.

### INTRODUCTION

Heat pump systems are often provided in vehicles for providing heating or cooling of a passenger compartment of the vehicle.

Aspects of the subject technology can help to improve the efficiency and/or performance of heat pump systems for electric vehicles, which can help to mitigate climate change by reducing greenhouse gas emissions.

### SUMMARY

Aspects of the subject disclosure relate to a heat pump system having a selectable bypass flow path that allows a refrigerant to bypass one or more heat exchangers of the heat pump system, and thereby provide a heating boost for a passenger compartment of a vehicle, particularly in ambient low-temperature environments.

In one or more aspects of the present disclosure, an apparatus is described. The apparatus may include a heat pump system. The heat pump may include a first refrigerant line connected to a compressor and a first heat exchanger. The heat pump system may further include a second refrigerant line connected to the first refrigerant line. The second refrigerant line may be in fluid communication with an accumulator. The heat pump system may further include a valve integrated with the second refrigerant line. A first position of the valve is configured to allow flow of a refrigerant from the compressor to the first heat exchanger, and a second position of the valve is configured to cause the flow of the refrigerant to bypass (e.g., partially bypass) the first heat exchanger and flow to the accumulator.

The heat pump system may be implemented in a vehicle, and the valve may be configured to partially direct the flow of the refrigerant from the first heat exchanger to the second refrigerant line based on at least one of an environmental condition or a mode of operation of the vehicle. The environmental condition may include a temperature, and in response to the temperature being below a threshold temperature, the valve is configured to operate in the second position. The first position may include a closed position of the valve, and the second position may include an open position of the valve. The mode of operation of the vehicle may include occupancy state the vehicle, and the heat pump system may be configured to heat a passenger compartment of the vehicle based on the occupancy state.

The heat pump system may further include a second heat exchanger. The heat pump system may further include a third refrigerant line connected to an outlet of the second heat exchanger. The second refrigerant line may be connected to a first inlet of the accumulator, and the third refrigerant line may be connected to a second inlet of the accumulator. The heat pump system may further include a fourth refrigerant line configured to connected to a third heat exchanger. The fourth refrigerant line may be connected to a third inlet of the accumulator. The valve, in the second position, may be further configured to cause the flow of the refrigerant to bypass (e.g., partially bypass) the second heat exchanger.

In one or more aspects of the present disclosure, a method is described. The method may include providing, via a first refrigerant line, a refrigerant from a compressor of a heat pump system to a first heat exchanger based on a first position of a valve. The method may further include monitoring, by a sensor, a condition. The method may further include in response to a determination the condition is below a threshold condition, providing, by a controller, instructions to transition the valve from the first position to a second position. The second position may be configured to cause the refrigerant to bypass (e.g., partially bypass) the first heat exchanger and flow to an accumulator of the heat pump system. The condition may include an environmental condition, and the threshold condition may include a threshold temperature. The method may further include providing the instructions to transition the valve from the first position to the second position may include transitioning the valve from a closed position of the valve to an open position of the valve.

The method may further include providing, via a second refrigerant line, the refrigerant in response to the valve being in the second position. The second refrigerant line may be connected to the accumulator. The valve, in the second position, may be further configured to cause the refrigerant to bypass at least a second heat exchanger. The first heat exchanger and the second heat exchanger may be in fluid communication in response to the valve being in the first position. The first position may include an open position of the valve, and the second position may include a closed position of the valve.

The method may further include monitoring a mode of operation of a vehicle. The mode of operation may include an occupancy state of the vehicle.

In one or more aspects of the present disclosure, an electric vehicle is described. The electric vehicle may include a heat pump system. The heat pump may include a first refrigerant line connected to a compressor and a first heat exchanger. The heat pump system may further include a second refrigerant line connected to the first refrigerant line. The second refrigerant line may be in fluid communication with an accumulator. The heat pump system may further include a valve integrated with the second refrigerant line. A first position of the valve is configured to allow flow of a refrigerant from the compressor to the first heat exchanger, and a second position of the valve is configured to cause the flow of the refrigerant to bypass (e.g., partially bypass) the first heat exchanger and flow to the accumulator.

The valve may be configured to switch the flow of the refrigerant from the first heat exchanger to the second refrigerant line based on at least one of an environmental condition or a mode of operation of the vehicle. The environmental condition may include a temperature, and in response to the temperature being below a threshold temperature, the valve is configured to operate in the second position. The first position may include an open position of the valve, and the second position may include a closed position of the valve.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a heat pump system, in accordance with one or more implementations of the present disclosure.

FIG. 2, FIG. 3, FIG. 4, and FIG. 5 illustrate schematic diagrams of heat pump systems, in accordance with one or more implementations of the present disclosure.

FIG. 6 illustrates a schematic and associated pressure-enthalpy diagram illustrating fundamentals of the refrigerant vapor compression cycle utilized by a heat pump system, in accordance with one or more implementations of the present disclosure.

FIG. 7 illustrates a perspective view of an embodiment of a valve, in accordance with one or more implementations of the present disclosure.

FIG. 8 illustrates a schematic diagram of an embodiment of a system having a valve for routing fluid throughout the system, in accordance with one or more implementations of the present disclosure.

FIG. 9A, FIG. 9B, FIG. 9C, FIG. 9D, FIG. 9E, FIG. 9F illustrate schematic diagrams showing different modes of the valve shown in FIG. 8 for regulation of flow, in accordance with one or more implementations of the present disclosure.

FIG. 10 illustrates a schematic diagram of an alternate embodiment of a heat pump system having a bypass flow path and including operable portions for providing heating and/or cooling to two or more portions and/or components of a vehicle or other apparatus, in accordance with one or more implementations of the present disclosure.

FIG. 11A, FIG. 11B, FIG. 11C, and FIG. 11D illustrate schematic diagrams showing different modes of the valve shown in FIG. 10 for regulation of flow, in accordance with one or more implementations of the present disclosure.

FIG. 12 illustrates a flow chart of illustrative operations that may be performed for operating a heat pump system having a bypass flow path, in accordance with one or more implementations of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology described herein relate to a heat pump system that includes a compressor, an accumulator, and one or more heat exchangers and a selectable bypass flow path that bypasses the heat exchanger(s). When refrigerant is rerouted around the heat exchanger(s) via the bypass flow path in some modes of operation, the refrigerant is routed from an outlet of the compressor, with the refrigerant under a relatively high pressure and temperature, to an inlet of the accumulator. Beneficially, a heating boost can be provided for one or more portions of an apparatus, such as a vehicle, that is heated by the heat pump system.

A heat pump system may include a refrigerant line and an expansion valve (EXV), each of which may be integrated with the heat pump system at the compressor outlet that bypasses one or more heat exchangers (and in some cases, all heat exchangers) and merges to the accumulator bottle inlet. In this regard, the refrigerant line may take the form of a bypass refrigerant line that feeds hot (e.g., superheated) refrigerant back to the accumulator to increase suction temperature and pressure and boost compressor heating performance. Alternatively, in another implementation, the refrigerant line and the EXV are added to the compressor outlet that bypasses one or more heat exchangers (and in some cases, all heat exchangers) and merges to the front evaporator outlet refrigerant line that goes to the accumulator bottle to boost compressor heating performance. When these features of the heat pump system are integrated with a vehicle, the compressor may provide heating under certain environmental conditions, such as under ambient cold weather (e.g., −10 degrees Celsius or below) or internal (e.g., passenger compartment or cabin) temperature of a vehicle, and/or under certain modes of operation of the vehicle.

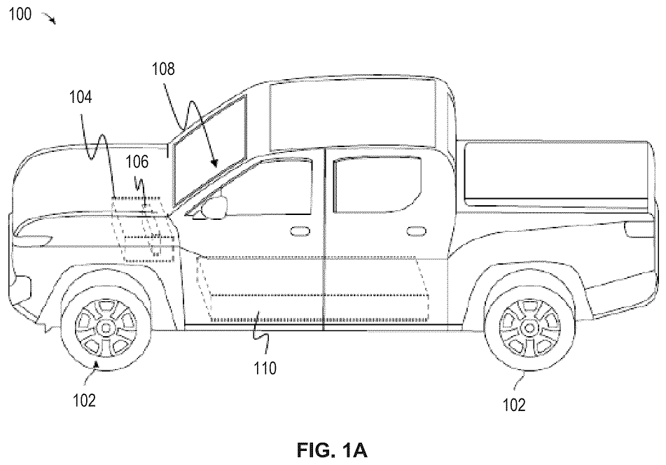

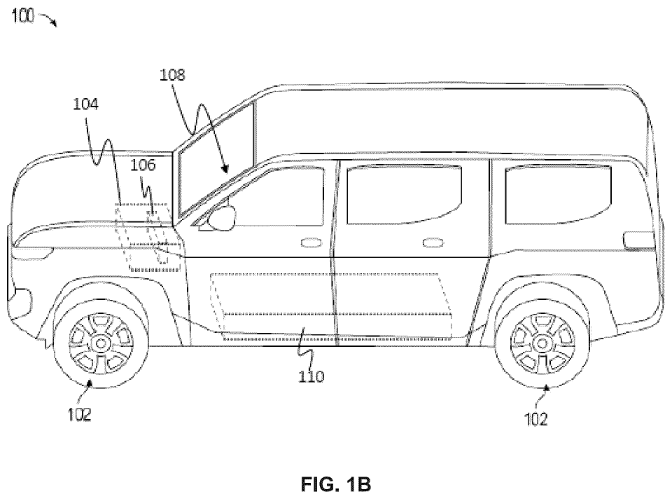

FIG. 1A is a diagram illustrating an example implementation of an apparatus as described herein. In the example of FIG. 1A, the apparatus is a moveable apparatus implemented as a vehicle 100. As shown, the vehicle 100 may include one or more batteries 110. The battery 110 may include on or more battery modules, which may include one or more battery cells, or may be provided without any battery modules (e.g., in a cell-to-pack configuration).

The battery 110 may be coupled to an electrical system of the vehicle 100, to receive power for charging of the battery and/or to provide power to an electrical system of the vehicle and/or to a thermal control system, such as a heat pump system 104. As shown, the heat pump system 104 may include an accumulator 106. For example, the accumulator 106 may be configured to buffer fluids (e.g., liquid refrigerant), which could include more liquid when the heat pump system 104 is used in cooling mode and less liquid when the heat pump system 104 used in a heating mode. The accumulator 106 may also be configured to separate fluid refrigerant from vapor refrigerant and help ensure that fluid exits with a saturated status to a compressor (e.g., for compressor protection), and to store and pick up oil for compressor oil lubrication.

Various features of the heat pump system 104 is described in further detail hereinafter. In one or more implementations, the heat pump system 104 may be operated to heat and/or cool various portions and/or components of the vehicle 100, such as a passenger compartment 108, various portions thereof, the battery 110, and/or power electronics of the vehicle 100.

In one or more implementations, the vehicle 100 may be an electric vehicle having one or more electric motors that drive the wheels 102 of the vehicle using electric power from the battery 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having a heat pump system 104 having an accumulator 106. However, the example of FIG. 1A in which the vehicle 100 is implemented as a pickup truck having a truck bed is merely illustrative. For example, FIG. 1B illustrates another implementation in which the vehicle 100 including the battery 110 and the heat pump system 104 including the accumulator 106 is implemented as a sport utility vehicle (SUV), such as an electric sport utility vehicle. In the example of FIG. 1B, the vehicle 100 including the battery 110 and the heat pump system 104 including the accumulator 106 may include a cargo storage area in at least a rear portion of the vehicle that is enclosed within the vehicle 100 (e.g., behind a row of seats within a cabin of the vehicle). In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having a battery 110 and a heat pump system 104 including an accumulator 106.

In one or more implementations, a heat pump system 104 as described herein may also, or alternatively, be implemented in another apparatus, such as a building (e.g., a residential home or commercial building, or any other building).

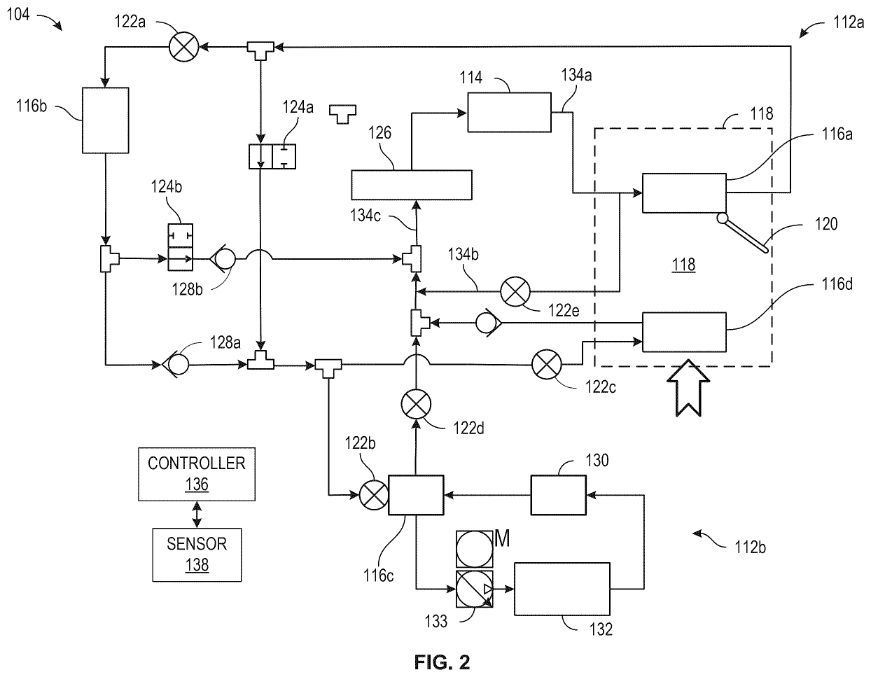

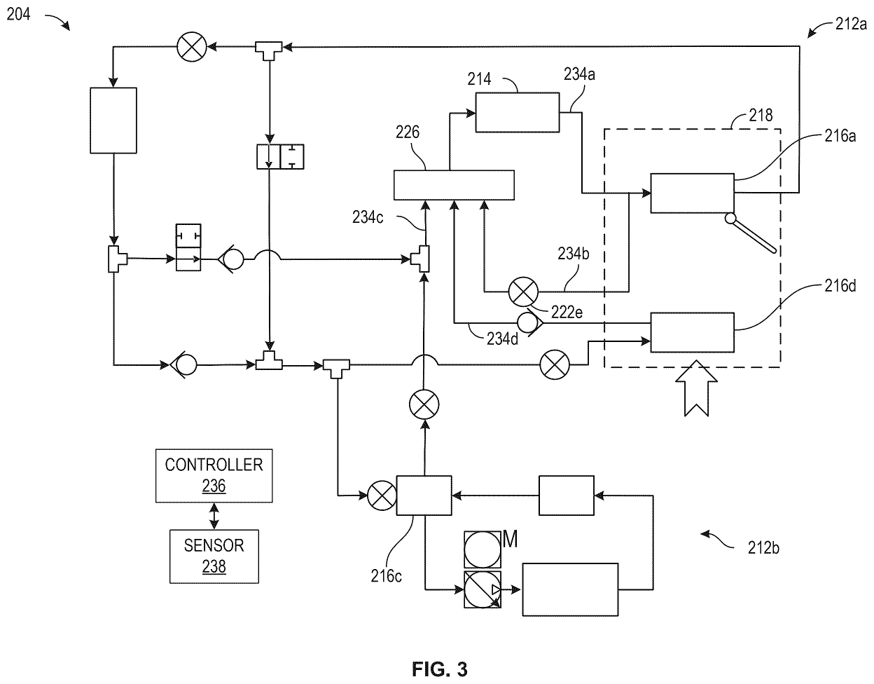

FIG. 2, FIG. 3, FIG. 4, and FIG. 5 illustrate schematic diagrams of heat pump systems, in accordance with one or more implementations of the present disclosure. For purposes of simplicity, some components (e.g., valves) are shown in FIG. 2, FIG. 3, FIG. 4, and FIG. 5 but are not labeled. Each of the heat pumps may be integrated with a vehicle (e.g., vehicle 100 shown FIG. 1A or 1B).

FIG. 2 illustrates a schematic diagram of an embodiment of a heat pump system 104, in accordance with one or more implementations of the present disclosure. The heat pump system 104 may take the form of a thermal management heat pump system. As shown, heat pump system 104 includes a thermal management loop 112a and a thermal management loop 112b. The thermal management loop 112a and the thermal management loop 112b may take the form of a cabin thermal management loop on the refrigerant side and an energy storage system (ESS) thermal management loop on the coolant side, respectively.

The thermal management loop 112a may include a compressor 114, which may take the form of an electric compressor for hybrid electric or pure electric vehicles (EVs), or a belt-driven compressor for internal combustion engine (ICE) vehicles. The compressor 114 may couple to a heat exchanger 116a. In FIG. 1, the heat exchanger 116a is a refrigerant-to-air condenser located within a heating, ventilation, and air conditioning (HVAC) case 118 to directly exchange heat with the cabin airflow. An alternate embodiment uses a refrigerant-to-coolant heat exchanger in conjunction with a loop involving a heater core to indirectly exchange heat with the cabin airflow. The HVAC case 118 may include a temperature blend door 120 located adjacent to the cabin condenser that allows full, partial, or no airflow by moving the door position accordingly. Optionally, the HVAC case 118 may further include a heater, e.g., a positive temperature coefficient (PTC) electrical heater, to provide supplemental heat when needed. Other components in a typical HVAC case, such as a blower, recirculation door, and mode selection door, are not depicted here and are known to those of ordinary skill in the art.

The heat exchanger 116a is coupled to a valve 122a. The term “coupled” may referred one structure (e.g., heat exchanger 116a) connected, including fluidly connected, to another structure 9 e.g., valve 122a). In one or more implementations, the valve 122a takes the form of an expansion valve (EXV), which operates in one of the three modes, an expansion mode to throttle high pressure refrigerant to low pressure refrigerant, an opening mode to allow free flow, and a closing mode to prevent any flow. The heat exchanger 116a is also coupled to a valve 124a. In one or more implementations, the valve 124a takes the form of a shut-off valve (SOV). As shown, the valve 124a is in parallel, which is operable for allowing or preventing refrigerant flow. The valve 122a is coupled to a heat exchanger 116b, which can be disposed at the front end of a vehicle and operable as a condenser to reject heat to the external fluid (e.g., air) or as an evaporator to absorb heat from the external fluid (e.g., air) depending upon the mode of operation.

The heat exchanger 116b is coupled to a valve 124b. In one or more implementations, the valve 124a takes the form of a SOV. Also, the heat exchanger 116b may take the form of an evaporator. The 124b may be positioned to allow or prevent refrigerant flow and coupled to an accumulator 126, as well as a valve 128a in parallel. In one or more implementations, the valve 128a takes the form of a check valve (CV). The accumulator 126 is a vessel which stores refrigerant and oil, ensures sufficient oil return, and allows essentially vapor refrigerant to return to the compressor 114. The compressor 114 may be used with high temperature, high pressure refrigerant, while the accumulator 126 may be used with low temperature, low pressure refrigerant. The compressor 114 may take in a refrigerant at a low temperature and pressure, and compress the refrigerant, resulting in a high-temperature, high-pressure refrigerant leaving the compressor 114. Accordingly, the refrigerant in the compressor 114 may be at relatively higher temperatures and pressures as compared to the refrigerant in the accumulator 126. The valve 128a is coupled to a heat exchanger 116b via a valve 122b (e.g., expansion valve), and to a heat exchanger 116d via a valve 122c (e.g., expansion valve). In FIG. 2, the heat exchanger 116d is a refrigerant-to-air evaporator located within the HVAC case 118 for cooling the cabin airflow. An alternate embodiment using a refrigerant-to-coolant heat exchanger in conjunction with a loop involving a cooler core to indirectly exchange heat with the cabin airflow can be understood by those with ordinary skill in the art. Additionally, the heat pump system 104 may include a valve 122d (e.g., EXV) that operates in at least an expansion mode to throttle high pressure refrigerant to low pressure refrigerant and a closing mode to prevent any flow, while the valve 122c operates in one of the three modes, an expansion mode to throttle high pressure refrigerant to low pressure refrigerant, an opening mode to allow free flow, and a closing mode to prevent any flow, similar to the valve 122a. The valve 122d may be optional. In this regard, in one or more implementations, the heat pump system 104 does not include the valve 122d. Considerations for the use of the valve 122d may include, for example, heating performance and cost. The heat exchanger 116a is coupled to the accumulator 126, and the heat exchanger 116d is coupled to the accumulator 126 to allow refrigerant flow into the accumulator 126 and ultimately return to the compressor 114. Additionally, the heat pump system 104 may include a valve 128b and a valve 128c, each of which may take the form of a check valve (CV). Each of the valves 128a and 128b may prevent backflow/charge migration.

The thermal management loop 112a is coupled with the thermal management loop 112b via a heat exchanger 116c. The thermal management loop 112b generally includes an ESS 130, such as a battery or battery pack. Optionally, a heater 132 may be included to assist heating. Collectively, the ESS 130, the heat exchanger 116c, a coolant pump assembly 133, and the heater 132 are operable for controlling the environment associated with the ESS 130.

Further, the heat pump system 104 may include a refrigerant line 134a connected to the compressor 114 and the heat exchanger 116a. As shown, the refrigerant line 134a is connected to an outlet of the compressor 114 and to an inlet of the heat exchanger 116a. The heat pump system 104 may include a refrigerant line 134b connected to the refrigerant line 134a, which may be in fluid communication with the accumulator 126 via a refrigerant line 134c. As shown, the refrigerant line 134c is connected to an inlet of the accumulator 126. In this regard, the refrigerant line 134b forms in part a recirculation line between the compressor 114 and the accumulator 126.

Further, a valve 122e (e.g., EXV) is integrated with the refrigerant line 134b and accordingly, the valve 122e is in fluid communication with the compressor 114 and the accumulator 126. In particular, the valve 122e is in fluid communication with an outlet of the compressor 114 at a connection point between the compressor 114 and the heat exchanger 116a. In this regard, when the valve 122e is in a closed position, refrigerant (not shown in FIG. 2) may flow from the compressor 114 to the heat exchanger 116a. Conversely, when the valve 122e is in an open position, the refrigerant line 134b forms a bypass refrigerant line that causes the refrigerant to bypass, or at least partially bypass, the heat exchanger 116a and merges (e.g., directly merges) the accumulator 126. Accordingly, the refrigerant may flow to the accumulator 126 in the open position of the valve 122e. As a result, the refrigerant line 134b may feed hot refrigerant back to the accumulator 126 to increase suction temperature and pressure and boost heating performance of the compressor 114. Additionally, when the valve 122e is in the open position, the refrigerant may bypass each of the heat exchangers 116b, 116c, and 116d, representing all of the heat exchangers of the heat pump system 104. Refrigerant flow at the outlet of the compressor 114 splits, with one refrigerant path going to one or more of the heat exchanger(s) to heat the cabin of the vehicle, the ESS 130, or both, and the other refrigerant path going to the bypass line to boost low side temperature and pressure. Some valves (e.g., valves 122a) may with other valves (e.g., valve 122e, valves 124a and 124b) to properly split the refrigerant flow to achieve the heating purposes.

Additionally, a controller 136 (e.g., microcontroller, MEMS controller, integrated circuit(s)) may provide instructions or commands to operate the heat pump system 104. Further, a sensor 138 may be electrically coupled with the controller 136. In one or more implementations, the sensor 138 takes the form of a temperature sensor (e.g., thermocouple, thermistor, coolant temperature sensors, cell temperature sensors, etc.). Further, the sensor 138 may be positioned in a vehicle (e.g., vehicle 100 shown FIG. 1A or 1B) to detect an environmental condition, such as ambient temperature. In this regard, the sensor 138 may provide an input (e.g., electrical signal) to the controller 136, with the input being indicative of the ambient temperature. The controller 136 may compare the environmental condition with a threshold condition, and provide an instruction to the valve 122e based on the comparison between the conditions. For example, the controller 136 may compare the ambient temperature with a threshold temperature, and provide instructions to open the valve 122e based on a determination by the controller 136 that the ambient temperature is at or below the threshold temperature. The controller 136 may instruct the valve 122e to remain closed when the ambient temperature is above the threshold temperature. Alternatively, or in combination, the sensor 138 may detect internal conditions, such as temperature in a passenger compartment (e.g., passenger compartment 108 shown in FIGS. 1A and 1B) a vehicle. The controller 136 may use the input to operate the valve 122e (e.g., compare the passenger compartment temperature with a threshold temperature to determine whether to open or close the valve 122e). For example, the controller 136 may open the valve 122e when the controller 136 determines, based on the input from the sensor 138, the temperature is at or below a threshold temperature. In one or more implementations, the threshold temperature is −10 degrees Celsius. The threshold temperature may be selected from values approximately in the range of −20 to 0 degrees Celsius. As a result, the heat pump system 104 may provide enhanced heating performance, via the compressor 114, under low-temperature conditions.

Additionally or alternatively, the controller 136 may control the valve 122e based on a mode of operation of a vehicle. In this regard, the sensor 138 may take the form of an occupancy sensor, which may be implemented as weight sensor or pressure sensor (e.g., measuring the weight change at a seat of the vehicle to determine whether a passenger is seated on the vehicle), an image sensor (e.g., camera) to camera one or more images of passenger compartment of a vehicle to determine whether an occupant(s) is/are in the vehicle, or a combination thereof., as non-limiting examples. As examples, the mode of operation of the vehicle may include a charging mode of the vehicle and/or an occupant state of the vehicle. For example, the charging mode may be an idle mode in which the battery 110 (shown in FIGS. 1A and 1B) of the vehicle 100 is not being charged, a standard charging mode in which the battery 110 of the vehicle 100 is being charged at a first rate, or a fast charging mode (e.g., a direct current (DC) fast charging mode) in which the battery 110 of the vehicle 100 is being charged at a second rate that is higher than the first rate. The occupant state of the vehicle may include an occupied state in which one or more occupants are in the passenger compartment 108 (shown in FIGS. 1A and 1B) of the vehicle 100, or an unoccupied state in which no occupants are in the passenger compartment 108 of the vehicle The heating state of the vehicle may include an active heating state in which the heat pump system 104 is being operated to heat or more portions of the passenger compartment 108 of the vehicle (e.g., the vehicle's climate control system is on). The sensor 138 may include a current sensor or voltmeter designed to monitor current or voltage, respectively, which may be used to determine a charge state.

FIG. 3 illustrates a schematic diagram of an alternate embodiment of a heat pump system 204, in accordance with one or more implementations of the present disclosure. As shown, heat pump system 204 includes a thermal management loop 212a and a thermal management loop 212b. The thermal management loop 212a and the thermal management loop 212b may take the form of a cabin thermal management loop on the refrigerant side and an ESS thermal management loop on the coolant side, respectively. The heat pump system 204 includes a heat exchanger 216a and a heat exchanger 216d, each of which is part of an HVAC case 218. Further, the heat pump system 204 may include a refrigerant line 234a connected to a compressor 214 and the heat exchanger 216a. As shown, the refrigerant line 234a is connected to an outlet of the compressor 214 and to an inlet of the heat exchanger 216a. The heat pump system 204 may include a refrigerant line 234b connected to the refrigerant line 234a, which may be in fluid communication with an accumulator 226. In this regard, the refrigerant line 234b forms in part a recirculation line between the compressor 214 and the accumulator 226. The compressor 214 may be used with high temperature, high pressure refrigerant, while the accumulator 226 may be used with low temperature, low pressure refrigerant. The compressor 114 may take in a refrigerant at a low temperature and pressure, and compress the refrigerant, resulting in a high-temperature, high-pressure refrigerant leaving the compressor 114. Accordingly, the refrigerant in the compressor 214 may be at relatively higher temperatures and pressures as compared to the refrigerant in the accumulator 226.

Further, a valve 222e (e.g., EXV) is integrated with the refrigerant line 234b and accordingly, the valve 222e is in fluid communication with the compressor 214 and the accumulator 226. In particular, the valve 222e is in fluid communication with an outlet of the compressor 214 at a connection point between the compressor 214 and the heat exchanger 216a. In this regard, when the valve 222e is in a closed position, refrigerant (not shown in FIG. 2) may flow from the compressor 214 to the heat exchanger 216a. Conversely, when the valve 222e is in an open position, the refrigerant line 234b forms a bypass refrigerant line that causes the refrigerant to bypass, or at least partially bypass, the heat exchanger 216a and merges (e.g., directly merges) the accumulator 226. Accordingly, the refrigerant may flow to the accumulator 226 in the open position of the valve 222e. As a result, the refrigerant line 234b may feed hot refrigerant back to the accumulator 226 to increase suction temperature and pressure and boost heating performance of the compressor 214. Additionally, when the valve 222e is in the open position, the refrigerant may bypass, or at least partially bypass, each of the heat exchanger of the heat pump system 204.

The heat pump system 204 may further include a refrigerant line 234c is connected to an inlet of the accumulator 226 and indirectly (or in some cases, directly) connected to a heat exchanger 216c of the thermal management loop 212b. The heat pump system 204 may further include a refrigerant line 234d connected to an outlet of the heat exchanger 216d and to an inlet of the accumulator 226. In this regard, the accumulator 226 includes three inlets (e.g., a first inlet, a second inlet, and a third inlet), with each inlet being separate from the remaining inlet and connected to one of the refrigerant lines 234b, 234c, and 234d. Also, the heat pump system 204 may include a controller 236 and a sensor 238, with the controller 236 designed to control the valve 222e, using the sensor 238, in a manner previously described.

FIG. 4 illustrates a schematic diagram of an alternate embodiment of a heat pump system 304, in accordance with one or more implementations of the present disclosure. As shown, heat pump system 304 includes a thermal management loop 312a and a thermal management loop 312b. The thermal management loop 312a and the thermal management loop 312b may take the form of a cabin thermal management loop on the refrigerant side and an ESS thermal management loop on the coolant side, respectively. The heat pump system 304 includes a heat exchanger 316a and a heat exchanger 316d, each of which is part of an HVAC case 318. Further, the heat pump system 304 may include a refrigerant line 334a connected to a compressor 314 and the heat exchanger 316a. As shown, the refrigerant line 334a is connected to an outlet of the compressor 314 and to an inlet of the heat exchanger 316a. The heat pump system 304 may include a refrigerant line 334b connected to the refrigerant line 334a, which may be in fluid communication with an accumulator 326. In this regard, the refrigerant line 334b forms in part a recirculation line between the compressor 314 and the accumulator 326. The compressor 314 may be used with high temperature, high pressure refrigerant, while the accumulator 326 may be used with low temperature, low pressure refrigerant. Accordingly, the refrigerant in the compressor 314 may be at relatively higher temperatures and pressures as compared to the refrigerant in the accumulator 326.

Further, a valve 322 (e.g., EXV) is integrated with the refrigerant line 334b and accordingly, the valve 322 is in fluid communication with the compressor 314 and the accumulator 326. In particular, the valve 322 is in fluid communication with an outlet of the compressor 314 at a connection point between the compressor 314 and at least indirectly connected to an inlet of the accumulator 326. Further, the valve 322 is in fluid communication with an outlet of the heat exchanger 316d. In this regard, when the valve 322 is in a closed position, refrigerant (not shown in FIG. 4) may flow from the compressor 314 to the heat exchanger 316a. Conversely, when the valve 322 is in an open position, the refrigerant line 334b forms a bypass refrigerant line that causes the refrigerant to bypass, or at least partially bypass, the heat exchanger 316a and merges (e.g., directly merges) to an outlet of the heat exchanger 316d, with the outlet connected to a refrigerant line 334c that is connected to the accumulator 326. Accordingly, the refrigerant may flow to the accumulator 326 in the open position of the valve 322. As a result, the refrigerant lines 334b and 334c may feed hot refrigerant back to the accumulator 326 to increase suction temperature and pressure and boost heating performance of the compressor 314. Additionally, when the valve 322 is in the open position, the refrigerant may bypass each of the heat exchanger of the heat pump system 304. Also, the heat pump system 304 may include a controller 336 and a sensor 338, with the controller 336 designed to control the valve 322, using the sensor 338, in a manner previously described. Also, based on the merger of the valve 322 with the outlet of the heat exchanger 316d, the HVAC case 318 may include the valve 322. Beneficially, the HVAC case 318 may be installed as a sub-assembly as the valve 322 is not an externally located valve.

FIG. 5 illustrates a schematic diagram of an alternate embodiment of a heat pump system 404, in accordance with one or more implementations of the present disclosure. As shown, heat pump system 404 includes a thermal management loop 412a and a thermal management loop 412b. The thermal management loop 412a and the thermal management loop 412b may take the form of a cabin thermal management loop on the refrigerant side and an ESS thermal management loop on the coolant side, respectively. The heat pump system 404 includes a heat exchanger 416a and a heat exchanger 416d, each of which is part of an HVAC case 418. Further, the heat pump system 404 may include a refrigerant line 434a connected to a compressor 414 and the heat exchanger 416a. As shown, the refrigerant line 434a is connected to an outlet of the compressor 414 and to an inlet of the heat exchanger 416a. The heat pump system 404 may include a refrigerant line 434b connected to the refrigerant line 434a, which may be in fluid communication with an accumulator 426. In this regard, the refrigerant line 434b forms in part a recirculation line between the compressor 414 and the accumulator 426. The compressor 414 may be used with high temperature, high pressure refrigerant, while the accumulator 426 may be used with low temperature, low pressure refrigerant. Accordingly, the refrigerant in the compressor 414 may be at relatively higher temperatures and pressures as compared to the refrigerant in the accumulator 426.

Further, a valve 422 (e.g., EXV) is integrated with the refrigerant line 434b and accordingly, the valve 422 is in fluid communication with the compressor 414 and the accumulator 426 via refrigerant line 434c. In particular, the valve 422 is in fluid communication with an outlet of the compressor 414 at a connection point between the compressor 414 and at least indirectly connected to an inlet of the accumulator 426. Also, the heat pump system 404 may include a controller 436 and a sensor 438, with the controller 436 designed to control the valve 422, using the sensor 438, in a manner previously described. Additionally, the heat pump system 404 may include a refrigerant line 434d connected, or at least indirectly connected, to an outlet of the heat exchanger 416d. The heat pump system 404 may further include a valve 428 (e.g., check valve) designed to prevent flow (e.g., backflow) of refrigerant in the refrigerant line 434d from entering the outlet of the heat exchanger 416d.

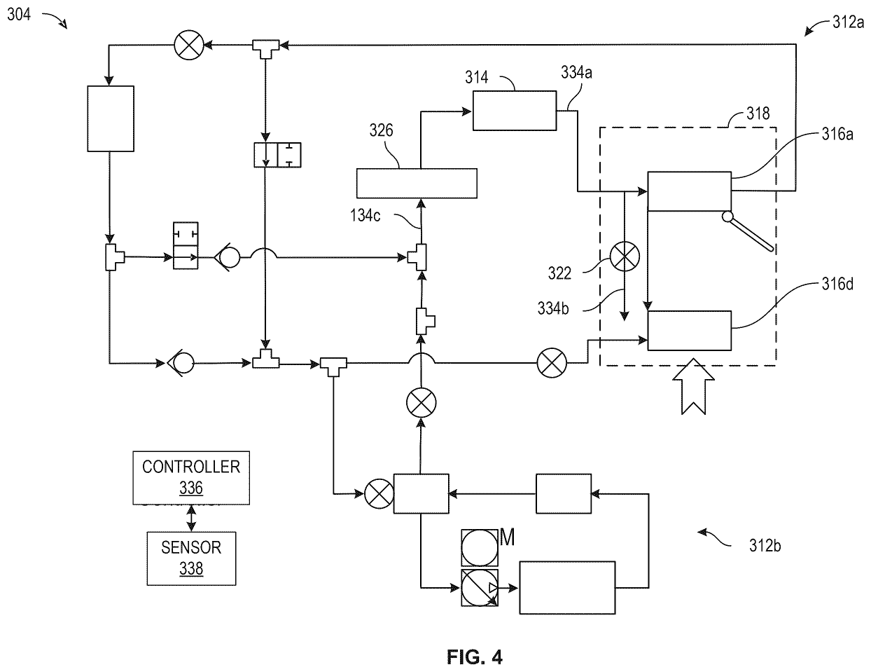

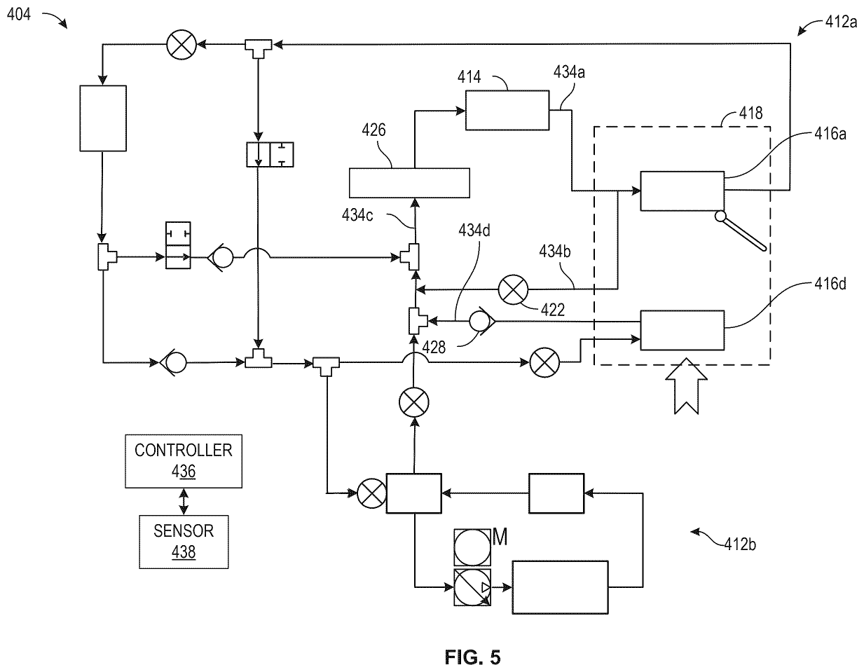

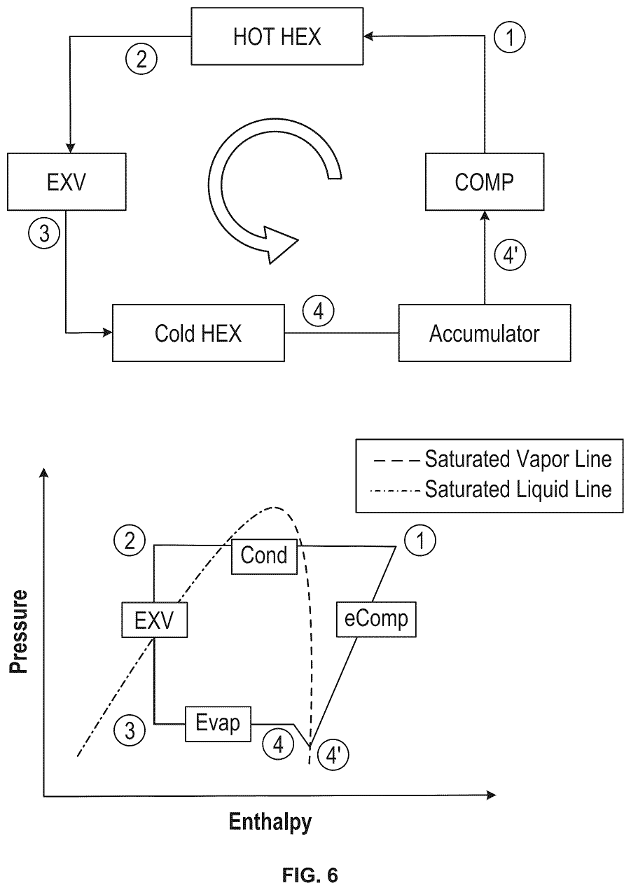

FIG. 6 illustrates a schematic and associated pressure-enthalpy diagram (for subcritical refrigerant like R134a or R1234yf) illustrating fundamentals of the refrigerant vapor compression cycle utilized by a heat pump system (e.g., heat pump systems 104, 204, 304, and 204 shown in FIG. 2, FIG. 3, FIG. 4, and FIG. 5, respectively) of the present disclosure. A refrigerant is compressed into high-pressure, high-temperature vapor and discharged out of the compressor (point 1). The high-pressure, high-temperature vapor rejects heat via a hot heat exchanger (e.g., the cabin condenser or outside heat exchanger) to the external fluid (e.g., air) and condenses to high-pressure, intermediate-temperature liquid at the outlet of the hot heat exchanger (point 2). An expansion valve throttles the high-pressure, intermediate-temperature liquid into a low-pressure, low-temperature liquid-vapor mixture (point 3), which enters a cold heat exchanger (e.g., the evaporator or chiller) to absorb heat from the external fluid (e.g., air or coolant) and boils into low-pressure, low-temperature, essentially vapor (i.e., pure vapor or predominately vapor with a small portion of liquid) at the outlet of the cold heat exchanger (point 4). The low-pressure, low-temperature, essentially vapor refrigerant enters an accumulator, experiences pressure loss to point 4′, and flows back to the compressor also in a low-pressure, low-temperature, essentially vapor status to complete the cycle. Dependent upon the mode of operation, different part(s) in a heat pump system may serve the function of a hot heat exchanger, an expansion valve, and a cold heat exchange.

There are generally three types of expansion valves: i) capillary tube (fixed orifice size; most simple), ii) thermal expansion valve (mechanical device to adjust the orifice size so that the outlet flow satisfies a preset status), and iii) electronic expansion valve (electronic device to adjust the orifice size so that the outlet flow satisfies a desired status; most advanced). The expansion valves shown and/or described in, for example, FIG. 2 may take the form of electronic expansion valves, although other valve assemblies are possible to achieve similar functions. Expansion valves described herein can achieve one the three modes, expansion, opening, and closing.

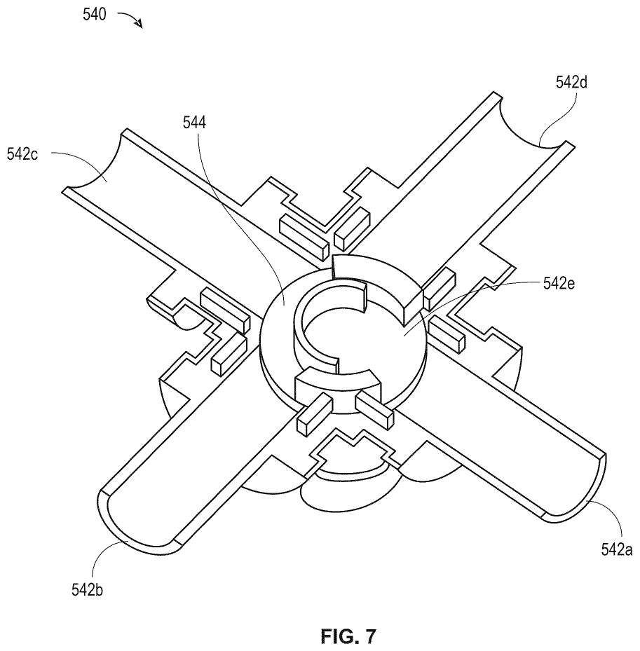

FIG. 7 illustrates a perspective view of an embodiment of a valve 540, in accordance with one or more implementations of the present disclosure. As shown, the valve 540 includes several ports. For example, the valve 540 includes a port 542a, a port 542b, a port 542c, a port 542d, and a port 542e. In this regard, the valve 540 may be characterized as a multi-port valve, including a five-way multi-port valve. Each of the ports 542a, 542b, 542c, 542d, and 542c through which a fluid (e.g., coolant) may flow. Further, the port 542e may be formed in part by a movable object 544 of the valve 540. The movable object 544 may be driven (e.g., rotationally driven) by a motor (not shown in FIG. 7), such as a servomotor or other DC motor. As a result, when the port 542e is driven in accordance with one or more particular manners, the valve 540 may place two or more valves in fluid communication with each other. This will be shown in further detail below. Also, while the valve 540 is shown as being a 5-port valve, the valve may include a different number of ports. For example, the valve 540 may take the form of a 6-port valve.

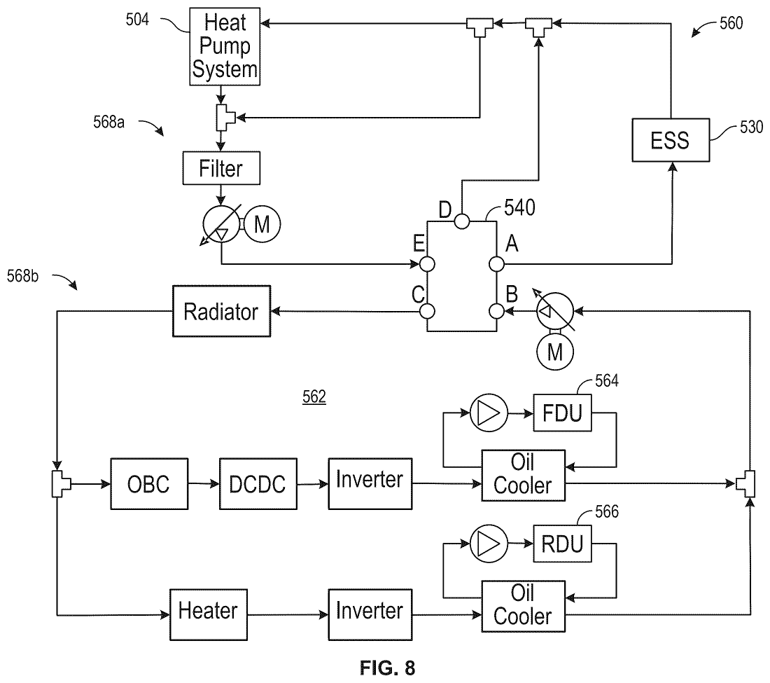

FIG. 8 illustrates a schematic diagram of an embodiment of a system 560 having a valve 540 for routing fluid throughout the system 560, in accordance with one or more implementations of the present disclosure. As shown, the system 560 includes a heat pump system 504 and a coolant system 562. The coolant system 562 is designed to cool various vehicle components, such as an ESS 530a, a front drive unit 564 (e.g., front motor), and a rear drive unit 566 (e.g., rear motor). The front drive unit 564 and the rear drive unit 566 may combine to form in part a powertrain of a vehicle. The system 560 may include multiple loops, such as a loop 568a (ESS loop) and a loop 568b (powertrain loop). The loops 568a and 568b may be joined in parallel or in series, or may be bypassed or partially bypassed.

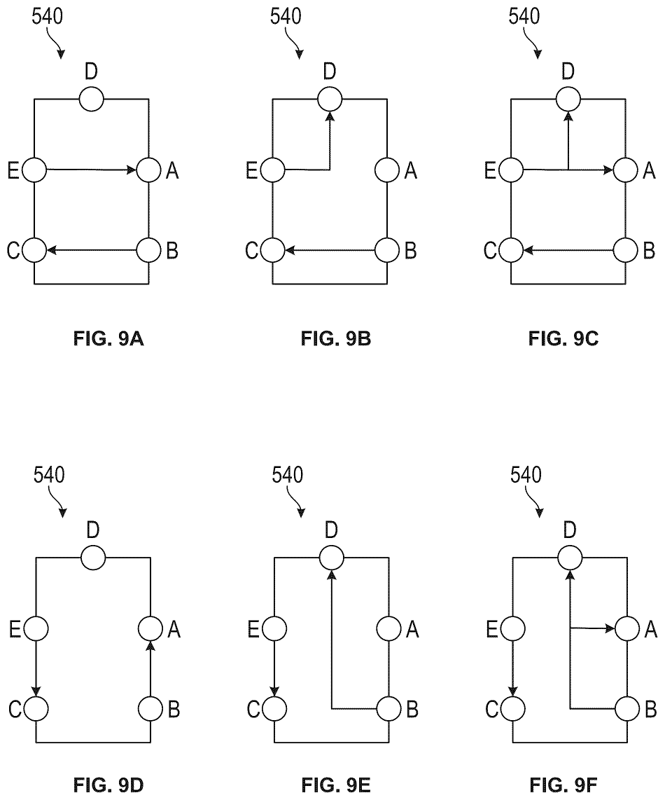

FIG. 9A, FIG. 9B, FIG. 9C, FIG. 9D, FIG. 9E, FIG. 9F illustrate schematic diagrams showing different modes of the valve 540 shown in FIG. 8 for regulation of flow, in accordance with one or more implementations of the present disclosure. Points A, B, C, D and E in FIGS. 9A-9F correspond to Points A, B, C, D and E in FIG. 8. Each of FIGS. 9A-9F represent a respective mode enabled by the valve 540 for the system 560 (show in FIG. 8), based on a position of the port 542e relative to the remaining ports (shown in FIG. 7).

FIG. 9A shows the valve 540 permitting flow from Point E to Point A and from Point B to Point C, thus placing the loops 568a and 568b (shown in FIG. 8) in parallel. FIG. 9B shows the valve 540 permitting flow from Point E to Point D and from Point B to Point C, thus placing the loops 568a and 568b in parallel, but bypassing the ESS 530. FIG. 9C shows the valve 540 permitting flow from Point E to Points A and D and from Point B to Point C, but partially bypassing the ESS 530. FIG. 9D shows the valve 540 permitting flow from Point E to Point C and from Point B to Point A, thus placing the loops 568a and 568b in series. FIG. 9E shows the valve 540 permitting flow from Point E to Point C and from Point B to Point D, thus placing the loops 568a and 568b in series, but bypassing the ESS 530. FIG. 9F shows the valve 540 permitting flow from Point E to Point C and from Point B to Points A and D, but partially bypassing the ESS 530.

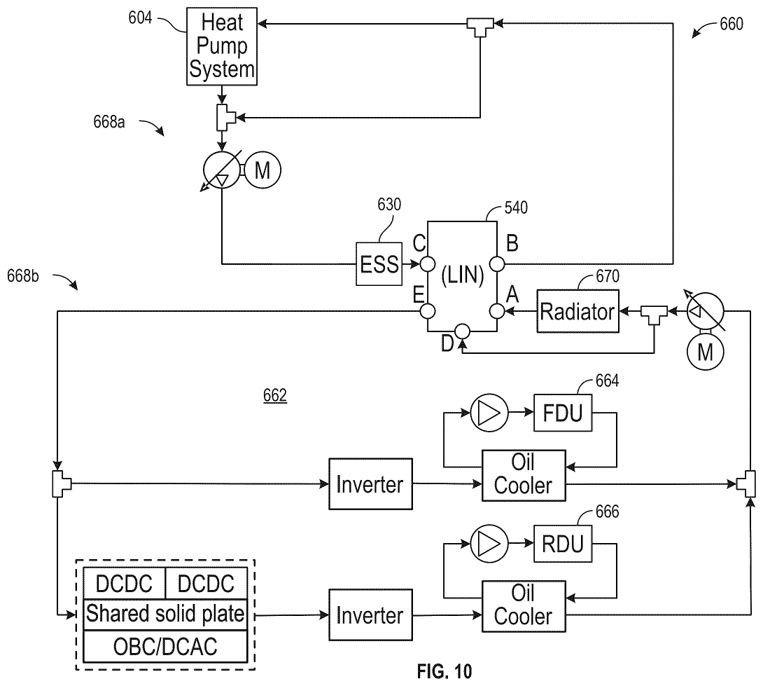

FIG. 10 illustrates a schematic diagram of an embodiment of a system 660 having a valve 540 for routing fluid throughout the system 660, in accordance with one or more implementations of the present disclosure. As shown, the valve 540 is oriented in a different manner as compared to FIG. 8. As shown, the system 660 includes a heat pump system 604 and a coolant system 662. The coolant system 662 is designed to cool various vehicle components, such as an ESS 630, a front drive unit 664 (e.g., front motor), and a rear drive unit 666 (e.g., rear motor). The front drive unit 664 and the rear drive unit 666 may combine to form in part a powertrain of a vehicle. Also, a radiator 670 may be connected with the coolant system 662. The system 660 may include multiple loops, such as a loop 668a (ESS loop) and a loop 668b (powertrain loop). The loops 668a and 668b may be joined in parallel or in series, or may be bypassed or partially bypassed. Based on the orientation of the valve 540, enhanced heating and cooling may be achieved.

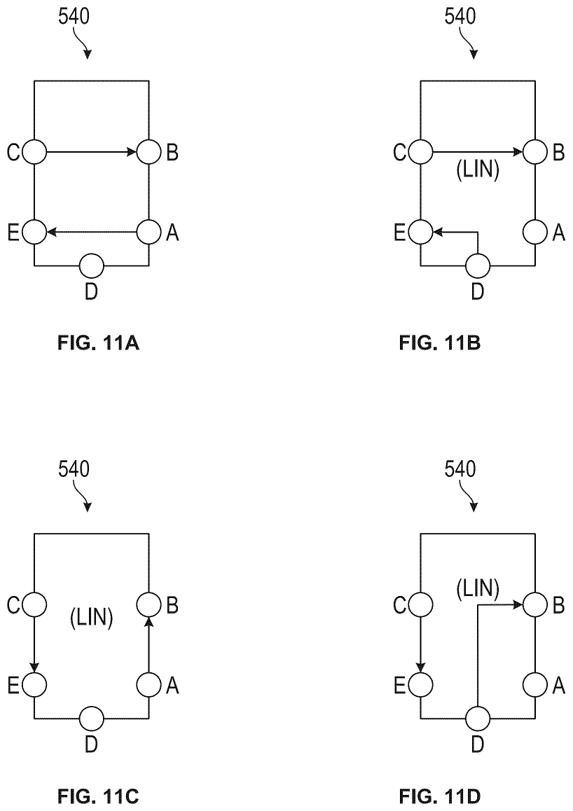

FIG. 11A, FIG. 11B, FIG. 11C, and FIG. 11D illustrate schematic diagrams showing different modes of the valve 540 shown in FIG. 10 for regulation of flow, in accordance with one or more implementations of the present disclosure. Points A, B, C, D and E in FIGS. 9A-9F correspond to Points A, B, C, D and E in FIG. 8. Each of FIGS. 9A-9F represent a respective mode enabled by the valve 540 for the system 660 (show in FIG. 10), based on a position of the port 542e relative to the remaining ports (shown in FIG. 7).

FIG. 11A shows the valve 540 permitting flow from Point A to Point E and from Point C to Point B, thus placing the loops 668a and 668b (shown in FIG. 10) in parallel. FIG. 11B shows the valve 540 permitting flow from Point C to Point B and from Point D to Point E, thus placing the loops 668a and 668b in parallel, but bypassing the radiator 670 (shown in FIG. 10). FIG. 11C shows the valve 540 permitting flow from Point C to Point E and from Point A to Point B, thus placing the loops 668a and 668b in series. FIG. 11D shows the valve 540 permitting flow from Point C to Point E and from Point D to Point B, thus placing the loops 668a and 668b in series, but bypassing the radiator 670.

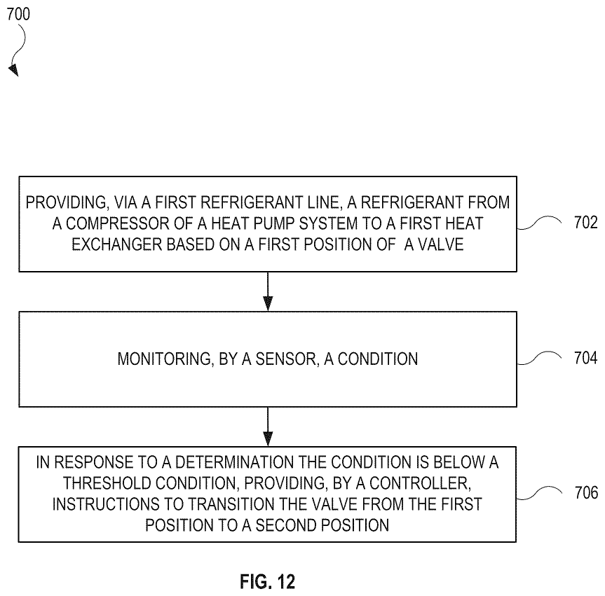

FIG. 12 illustrates a flow diagram of an example process for operating a heat pump system, in accordance with implementations of the subject technology. For explanatory purposes, the process 700 is primarily described herein with reference to the heat pump system 104 of FIGS. 205. However, the process 700 is not limited to the heat pump system 104 of FIGS. 2-5, and one or more blocks (or operations) of the process 700 may be performed by one or more other components of other suitable moveable apparatuses, devices, or systems. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, a refrigerant is provided, via a first refrigerant line (e.g., refrigerant line 134a shown in FIG. 2) from a compressor (e.g., compressor 114 shown in FIG. 2) of a heat pump system (e.g., heat pump system 104 shown in FIG. 2) to a first heat exchanger (e.g., heat exchanger 116a shown in FIG. 2) based on a first position (e.g., closed position) of a valve (e.g., valve 122e shown in FIG. 2).

At block 704, a sensor (e.g., sensor 138 shown in FIG. 2), a condition. The condition may include environmental conditions, such as under ambient cold weather (e.g., −10 degrees Celsius or below) or internal (e.g., passenger compartment or cabin) temperature of a vehicle, and/or under certain modes of operation of the vehicle.

At block 706, in response to a determination the condition is below a threshold condition, a controller (e.g., controller) provides instructions to transition the valve from the first position to a second position (e.g., open position). The second position is configured to cause the refrigerant to bypass the first heat exchanger and flow to an accumulator of the heat pump system.

The disclosed heating boost may help enable heating for vehicles with a larger cabin size (e.g., three rows of passenger seats), such as by boosting cabin heating performance and maintaining cabin comfort under col ambient and/or high solar load conditions while driving, idling, and/or DC fast charging, which can provide improved heating efficiency, and may also help improve occupant comfort, safety, experience, and satisfaction.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus, comprising:
a heat pump system comprising:
a first refrigerant line connected to a compressor and a first heat exchanger;
a second refrigerant line connected to the first refrigerant line, wherein the second refrigerant line is in fluid communication with an accumulator; and
a valve integrated with the second refrigerant line, wherein a first position of the valve is configured to allow flow of a refrigerant from the compressor to the first heat exchanger, and a second position of the valve is configured to cause the flow of the refrigerant to bypass the first heat exchanger and flow to the accumulator.

2. The apparatus of claim 1, wherein:
the heat pump system is implemented in a vehicle, and
the valve is configured to switch the flow of the refrigerant from the first heat exchanger to the second refrigerant line based on at least one of an environmental condition or a mode of operation of the vehicle.

3. The apparatus of claim 2, wherein:
the environmental condition comprises a temperature, and
in response to the temperature being below a threshold temperature, the valve is configured to operate in the second position.

4. The apparatus of claim 3, wherein:
the first position comprises a closed position of the valve, and
the second position comprises an open position of the valve.

5. The apparatus of claim 2, wherein:
the mode of operation of the vehicle comprises occupancy state the vehicle, and
the heat pump system is configured to heat a passenger compartment of the vehicle based on the occupancy state.

6. The apparatus of claim 1, wherein the heat pump system further comprises:
a second heat exchanger; and
a third refrigerant line connected to an outlet of the second heat exchanger, wherein:
the second refrigerant line is connected to a first inlet of the accumulator, and
the third refrigerant line is connected to a second inlet of the accumulator.

7. The apparatus of claim 6, wherein the heat pump system further comprises a fourth refrigerant line configured to connected to a third heat exchanger, wherein the fourth refrigerant line is connected to a third inlet of the accumulator.

8. The apparatus of claim 6, wherein the valve, in the second position, is further configured to cause the flow of the refrigerant to bypass the second heat exchanger.

9. A method, comprising:
providing, via a first refrigerant line, a refrigerant from a compressor of a heat pump system to a first heat exchanger based on a first position of a valve;
monitoring, by a sensor, a condition; and
in response to a determination the condition is below a threshold condition, providing, by a controller, instructions to transition the valve from the first position to a second position, wherein the second position is configured to cause the refrigerant to bypass the first heat exchanger and flow to an accumulator of the heat pump system.

10. The method of claim 9, wherein:
the condition comprises an environmental condition, and
the threshold condition comprises a threshold temperature.

11. The method of claim 9, wherein providing the instructions to transition the valve from the first position to the second position comprises transitioning the valve from a closed position of the valve to an open position of the valve.

12. The method of claim 9, further comprising providing, via a second refrigerant line, the refrigerant in response to the valve being in the second position, wherein the second refrigerant line is connected to the accumulator.

13. The method of claim 9, wherein the valve, in the second position, is further configured to cause the refrigerant to bypass at least a second heat exchanger.

14. The method of claim 13, wherein the first heat exchanger and the second heat exchanger are in fluid communication in response to the valve being in the first position.

15. The method of claim 9, wherein:
the first position comprises an open position of the valve, and
the second position comprises a closed position of the valve.

16. The method of claim 9, further comprising monitoring a mode of operation of a vehicle, wherein the mode of operation comprises an occupancy state of the vehicle.

17. An electric vehicle, comprising:
a heat pump system comprising:
a first refrigerant line connected to a compressor and a heat exchanger;
a second refrigerant line connected to the first refrigerant line, wherein the second refrigerant line is in fluid communication with an accumulator; and
a valve integrated with the second refrigerant line, wherein a first position of the valve is configured to allow flow of a refrigerant from the compressor to the heat exchanger, and a second position of the valve is configured to cause the flow of the refrigerant to bypass the heat exchanger and flow to the accumulator.

18. The electric vehicle of claim 17, wherein the valve is configured to switch the flow of the refrigerant from the heat exchanger to the second refrigerant line based on at least one of an environmental condition or a mode of operation.

19. The electric vehicle of claim 18, wherein:
the environmental condition comprises a temperature, and
in response to the temperature being below a threshold temperature, the valve is configured to operate in the second position.

20. The electric vehicle of claim 19. wherein:
the first position comprises an open position of the valve, and
the second position comprises a closed position of the valve.
